(19) United States
(12) Patent Application Publication
(10) Pub. No.: US 2022/0132208 A1
(43) Pub. Date: Apr. 28, 2022

(54) PREDICTIVE PARENTAL CONTROLS FOR NETWORKED DEVICES

(71) Applicant: Avast Software s.r.o., Prague 4 (CZ)

(72) Inventors: Deepali Garg, San Jose, CA (US); John Poothokaran, Palo Alto, CA (US); Juyong Do, Cupertino, CA (US)

(73) Assignee: Avast Software s.r.o., Prague 4 (CZ)

(21) Appl. No.: 17/078,961

(22) Filed: Oct. 23, 2020

(51) Int. Cl. H04N 21/45; H04N 21/475; H04N 21/454

(52) U.S. Cl. CPC H04N 21/4532; G06F 2221/2149; H04N 21/4542; H04N 21/4751

(57) ABSTRACT

Permissions in a parental control system are managed by evaluating a set of current permissions settings, current interests, and the age of at least one child subject to the current permissions to derive one or more suggested modifications to the current permissions. The one or more suggested modifications are determined to be age appropriate for the at least one child and to be of interest to the child. The one or more current interests comprise prior usage data of the at least one child.

### FIELD

The invention relates generally to computer network devices, and more specifically to predictive parental controls for networked devices such as smart phones, tablets, and computers.

### BACKGROUND

Computers are valuable tools in large part for their ability to communicate with other computerized devices and exchange information over computer networks. Networks typically comprise an interconnected group of computers, linked by wire, fiber optic, radio, or other data transmission means, to provide the computers with the ability to transfer information from computer to computer. The Internet is perhaps the best-known computer network, enabling billions of people to access billions of other computers such as by viewing web pages, sending e-mail, engaging in e-commerce, accessing or controlling smart devices such as thermostats or security systems, or by performing other computer-to-computer communication.

But, because the size of the Internet is so large and Internet users are so diverse in their interests, it is not uncommon for malicious users to attempt to communicate with other users' computers in a manner that poses a danger to the other users. For example, a hacker may attempt to log in to a corporate computer to steal, delete, or change information. Computer viruses or Trojan horse programs may be distributed to other computers or unknowingly downloaded such as through email, download links, or smartphone apps, and used for purposes such as to steal personally identifiable information or to otherwise take advantage of children, the elderly, or vulnerable adults.

For example, online user activity such as banking, social media, and other network activity may be intercepted, monitored, or faked by a variety of software, computer systems, or network devices, enabling rogue actors to steal identities or personal information. A user's name, credit card information, address, and other such information are often used in conducting legitimate online commerce, but can be stolen and illegally used for everything from unauthorized purchases to stealing the user's identity. Further, some websites such as social media sites attempt to verify the authenticity of user accounts by asking for increasing amounts of Personally Identifiable Information (PII), which is often subject to data breaches by hackers and subject to misuse such as by selling such data to third parties for uses that do not benefit the users. Other bad actors attempt to exploit the relative naivety of children using online applications, websites, or other content, coaxing them into providing personally identifiable information (PII), by facilitating purchases such as in-game transactions without parental authorization, by providing content that is not age appropriate for the children, or by otherwise exploiting children. Similarly, some content intended for adults or older children is simply not appropriate for younger children.

For these and other reasons, some users wish to limit the content or the applications available to certain users such as minor children while using computerized devices such as smartphones or personal computers, protecting them from malicious users as well as keeping them from accessing content that is not age-appropriate. For example, a grade school child may be permitted to access YouTube Kids, but may not have access to YouTube. In another example, a ten year old may be able to access Pinterest, with its relatively robust safeguards against violence and sexually explicit content, but may not be able to access the more permissive Reddit (or may be restricted to viewing certain content or “subreddits” on that site).

But, as children get older and their interests change, the content that interests them and the relative danger of various threats to their online safety change. Some changes are due to the advancing age and maturing interests of the children, while others reflect a change in trends such as new or increasingly popular applications, such as the recent growth of TikTok as a short-format video sharing platform. For reasons such as these, managing changes in parental controls for children that reflect the childrens' advancing age and/or a changing landscape of digital content is desired.

### SUMMARY

One example embodiment comprises managing permissions in a parental control system by evaluating a set of current permissions settings, current interests, and the age of at least one child subject to the current permissions to derive one or more suggested modifications to the current permissions. The one or more suggested modifications are determined to be age appropriate for the at least one child and to be of interest to the child.

In a further example, the one or more current interests comprise prior usage data of the at least one child.

In another example, a visual representation of interests is displayed as a tree of most-used applications and/or websites and potential new application and/or websites for suggested permissions modifications, grouped by related application and/or website type

In some examples, a data set of activity of similar children is used to predict future interests of the at least one child for whom suggested permission modifications are being derived, such as by using the data set to train or construct a neural network, a Markov model, a decision tree, or other such machine learning or artificial intelligence system.

The details of one or more examples of the invention are set forth in the accompanying drawings and the description below. Other features and advantages will be apparent from the description and drawings, and from the claims.

### BRIEF DESCRIPTION OF THE FIGURES

FIG. 1 shows a parental control system operable to provide suggested permissions changes, consistent with an example embodiment.

FIG. 2 shows an interest tree for a child subject to the parental control system, consistent with an example embodiment.

FIG. 3 shows an interest tree where data from multiple branches is used to suggest a new application, consistent with an example embodiment.

FIG. 4 shows a future application prediction example for a child, consistent with an example embodiment.

FIG. 5 shows a model for generating parental controls using a neural network having long short-term memory (LSTM), consistent with an example embodiment.

FIG. 6 is a flowchart illustrating a method of generating suggested changes to parental controls, consistent with an example embodiment.

FIG. 7 is a computerized system comprising a user privacy module operable to generate a synthetic user profile and select a network egress point consistent with the synthetic profile, consistent with an example embodiment.

### DETAILED DESCRIPTION

In the following detailed description of example embodiments, reference is made to specific example embodiments by way of drawings and illustrations. These examples are described in sufficient detail to enable those skilled in the art to practice what is described, and serve to illustrate how elements of these examples may be applied to various purposes or embodiments. Other embodiments exist, and logical, mechanical, electrical, and other changes may be made.

Features or limitations of various embodiments described herein, however important to the example embodiments in which they are incorporated, do not limit other embodiments, and any reference to the elements, operation, and application of the examples serve only to define these example embodiments. Features or elements shown in various examples described herein can be combined in ways other than shown in the examples, and any such combinations is explicitly contemplated to be within the scope of the examples presented here. The following detailed description does not, therefore, limit the scope of what is claimed.

As networked computers and computerized devices such as smart phones become more ingrained into our daily lives, the value of the information they store, the data such as passwords and financial accounts they capture, and even their computing power becomes a tempting target for criminals. Hackers regularly attempt to log in to a corporate computer to steal, delete, or change information, or to encrypt the information and hold it for ransom via “ransomware.” Smartphone apps, Microsoft Word documents containing macros, Java applets, and other such common documents are all frequently infected with malware of various types, and users rely on tools such as antivirus software or other malware protection tools to protect their computerized devices from harm. Malicious users often attempt to steal user credentials to popular online websites or services by creating fake sites pretending to be the popular websites, or by stealing personal information stored in legitimate sites such as online commerce or social media websites.

Certain online user activities including banking, social media, and e-commerce are particular targets of hackers wishing to steal Personally Identifiable Information (often simply called PII), as such information is often used to verify the identity and legitimacy of users. But, such Personally Identifiable Information (PII) may be intercepted, monitored, or stolen by a variety of software, computer systems, or network devices, enabling rogue actors to steal personal information or identities. Some such online exploits are targeted at children, such as encouraging children to reveal Personally Identifiable Information or to engage in in-game transactions or other content purchases without authorization from an adult. Other online activities, such as viewing certain explicit, violent, or otherwise age-inappropriate content pose different risks to children, and are in some environments restricted by parental controls.

In one such example, a parental control application on a smartphone, tablet, or other device, limits operation of the device to certain applications while the device is in a locked or restricted mode for the child's use. The restrictions in various examples include preventing the child from making app store purchases or engaging in other online e-commerce or transactions, limiting the websites the child may visit if use of a browser is permitted, and limiting the applications and the amount of time and the times of day that certain applications or content may be used or viewed on the device.

But, children change quickly, as does the content available on the Internet. A seven year-old who was allowed to watch YouTube Kids but restricted from watching YouTube will soon be an eight year-old who is strongly interested in similar video content on the relatively new website and app TikTok, and it takes significant effort to track what content might be of interest to a child as the child's interests and the popularity and availability of various content changes. Further, determining what content may be age appropriate for a growing child can be time-consuming and is prone to error, such as when a seemingly benign application or site offers in-game purchases or microtransactions, or when a provider catering to a wide audience such as Reddit offers adult content that may not be apparent upon a quick review of the website or application.

Some examples described herein therefore provide a parental control system that generates recommended permissions changes for a parental control system based on factors such as an increase in a child's age, the child's expressed interests, and changes in available online content. In a more detailed example, permissions in a parental control system are managed through evaluating a set of current permissions settings and the age of the child subject to the current permissions to derive one or more suggested modifications to the current permissions. The one or more suggested modifications are determined to be age appropriate for the child and to be of interest to the child, and in further examples are based on additional factors such as the emergence of new content or increased popularity of content, and/or one or more expressed current interests of the child. The suggested permissions changes are in some examples generated automatically, such as after a certain period of time since the last permissions change or review, and in further examples are provided to a parent or guardian as recommendations or are automatically updated based on parental control settings.

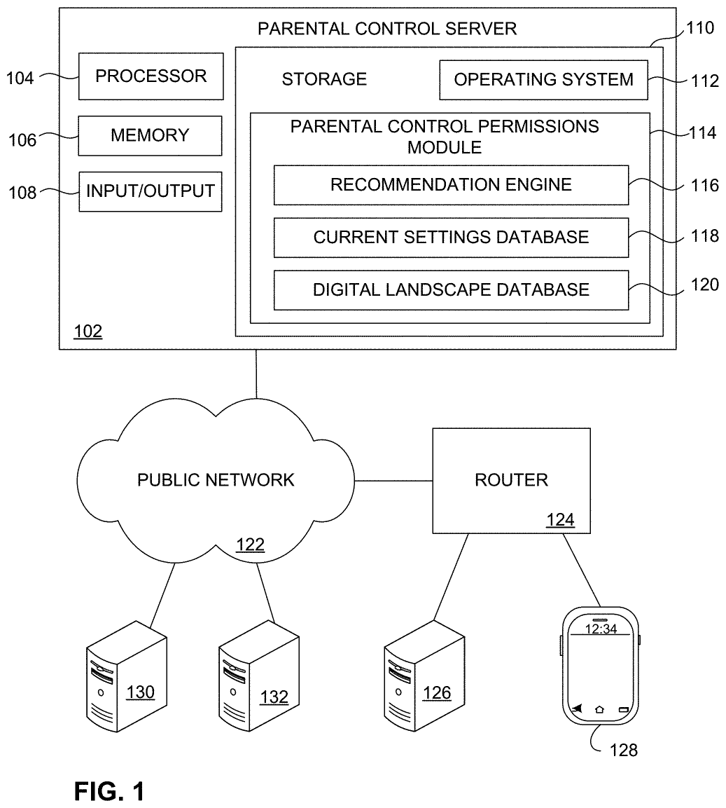

FIG. 1 shows a parental control system operable to provide suggested permissions changes, consistent with an example embodiment. Here, a parental control server 102 comprises a processor 104, memory 106, input/output elements 108, and storage 110. Storage 110 includes an operating system 112, and parental control permissions module 114 that is operable to provide recommended changes in permissions settings to a parent or guardian. The parental controls permissions module 114 further comprises a recommendation engine 116 operable to use data such as a current set of parental control permissions and digital landscape data such as popular applications/websites and associated demographics along with observed interests of a child subject to the parental controls to provide one or more recommended permission setting changes. Current settings database 118 contains current parental control permissions for the child, and digital landscape database 120 contains information regarding various content such as applications and websites along with demographic information associated with the content such as what type of content it is, an appropriate age range for the content, ages of typical interest for the content, and the like.

The Parental Control Server 102 is coupled to a public network 122 such as the Internet, and to other computers such as via router 124 to computer 126 and smartphone 128. Other computerized devices are connected directly to the public network rather than through a router. The computer 126 and smartphone 128 are end user devices that may be used to run various applications or to access Internet content such as via a web browser. In one such example, application backend server 130 and web server 132 are accessed by end user devices such as the smartphone 128.

In operation, a parent in control of the smartphone 128 or computer 126 installs parental control software on the device, which limits functionality of the device while in a restricted mode for a child's use. The restricted mode restricts what types of applications may be run or installed, what websites or other content may be visited or viewed, the amount of time per day and time of day that various applications or content may be used, purchases made using the device (such as app store purchases on a mobile device), and other such restrictions. These restrictions enable a child to use the device without constant supervision from an adult, and in a further example log and/or report the child's device use to the parent for assurance that the device is being used properly.

But, as the child's interests change over time and the child matures, the applications and web content appropriate for the child will change. Further, new applications and websites become popular and old ones fade away, such as when social media transitioned from early websites like MySpace to websites and applications like Facebook. For reasons such as these, the parental control software in some examples presented here is operable to recommend changes to parental controls, such as by periodically evaluating the parental controls applicable to a particular child and the age and interests of the child, and recommending changes to the parental control settings.

In a more detailed example, the parental control software executing on the end user's device such as computer 126 or smartphone 128 is operable to enforce the parental control settings, but receives recommendations for changes in parental control settings from a server such as parental control server 102. The server 102 performs a periodic review of the parental control settings on the end user device, such as after a certain number of days, weeks, or months since the last update or change to parental control settings, and provides one or more suggested setting changes to the parent through the end user device's parental control software. This enables the parent to keep settings up-to-date, reflecting the interests, age, and maturity level of their child.

The suggested modifications to parental control permissions are in some examples derived from the current permissions, such as may be uploaded to the parental control server 102's current settings database 118, and a landscape or data set of applications and websites that are of interest to other users in digital landscape database 120. The digital landscape database in a further example includes data indicating how various applications and web content are related or of interest to the same people, including grouping or clustering apps and web content such that similar content can be displayed to the parent as an interest tree or other visual representation to aid in understanding and selecting suggested permission changes.

For example, a child's interests may include various categories or combinations such as games, social, music, video, education, art, books, and news, and the types of interests expressed can be used to select new applications or web content consistent with those interests and/or to predict new interests as the child matures. Using a recommendation engine 116 such as a neural network, decision tree, or other artificial intelligence to evaluate the child's current permissions and age along with known relationships between applications and web content as well as data regarding interests of other similar children enable the recommendation to generate suggested permissions changes that are likely to be of interest to the child.

The parent receives the recommendations periodically, based on advancement in age, time passed since last recommendations or permissions updates, or triggered by degree of suggested change. In another example, a significant change such as rapid adoption of a new application (such as Zoom for remote learning and conferencing during an emerging pandemic) can trigger a suggested permissions update that might not otherwise meet the criteria for distribution.

When the parental control application on the end user device (or a web portal or other suitable interface to the parental control application) receives the suggested change from the parental control server, the parent is notified such as through an email or a notification on the device or on the parent's device. The parent in one example selects which suggested changes to accept or reject, while in another example some changes are automatically accepted based on previous configuration or authorization the parent provided to the parental control application. Notice of automatically accepted permissions changes are sent to the parent in a further example. In another example, suggested changes that a parent declines to accept are recorded in the parental control server, such as in the digital landscape database, so that such decisions can be used to improve recommendations for other parents regarding the same or similar applications or web content.

In a more sophisticated example, the parent is provided with an interest tree, or other graphical representation of current application and/or website permissions, along with additional related applications and/or websites that are not yet permitted but that are similar to or associated with allowed applications. The applications and websites that are not yet permitted in a further example are presented in a grouped and ordered manner along with associated permitted content, such as from basic applications or content appealing to younger children near the trunk of an interest tree with more sophisticated or mature applications and web content appearing progressively further out on the same branch of the interest tree, with each branch representing a group of applications and/or web content that have similar content and appeal to children with the same interests.

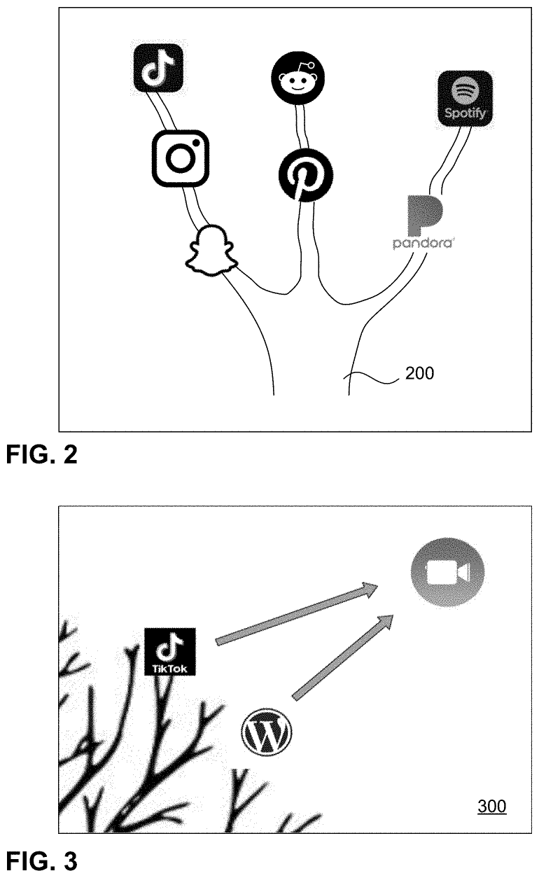

FIG. 2 shows an interest tree for a child subject to the parental control system, consistent with an example embodiment. Here, the tree shown generally at 200 includes three different branches, showing changing interests over time in three different areas of interest. The left-most branch represents video and picture sharing, the right-most branch represents streaming music, and the middle branch represents social media content sharing. The changes in each interest area include both prior parental control decisions, such as to allow Snapchat access for the child, as well as likely future interests, such as Instagram and TikTok, as represented on the left-most branch of the interest tree. In this example, Instagram represents a future interest that may be determined to be newly age-appropriate for the child based on the child's advancing age, while TikTok represents a future interest suggested based on rapidly increasing popularity and suitability for a wide range of ages. Similarly, the left-most branch shows migration from Pandora to Spotify, not based on age, but based on a shift in user preference from people who use Pandora to move to Spotify as their preferred streaming music source. In the middle branch of the tree, children who have an interest in Pinterest as a social media content sharing site are predicted to eventually have an interest in Reddit, which similarly offers social media content sharing with more mature and varied themes.

In a more detailed example, the most-used applications or websites for a particular child are displayed as major interests, such as the root application on each displayed tree branch. In an alternate example, more recently used applications are also prioritized, such as being displayed on outer branches of the tree. Applications and web content are grouped by category or type and other characteristics, including in some example statistical correlation in interest between applications and/or web content. The interest tree grows by extrapolating current activity trends and interests into anticipated future interests based on observations of other children, such as by looking at a specific child's past activity and using data regarding other children who have had similar past activity and their later interests to predict future interests of the specific child. New application and/or web content prediction in one such example uses current application usage data and the child's age as inputs, and uses a time series analysis, neural network, expert system, decision tree, Markov model, long short-term memory model such as a recurrent or convolutional neural network, or other such model to produce an output indicating one or more recommended applications and/or web content providers. These recommended applications and/or web content providers are in a further example displayed on an interest tree such as that of FIG. 2, as a graphical aid in understanding a child's past application and/or web content usage and suggested changes to the parental control settings to allow additional applications and/or web content.

FIG. 3 shows an interest tree where data from multiple branches is used to suggest a new application, consistent with an example embodiment. As shown generally at 300, a child has shown an interest in TikTok, which is a short-form video sharing site, and in WordPress, which is a blogging or web page publication site. Based on a combination of these two interests, the iOS video creation app is being recommended for the child to facilitate creation of video content for sharing on sites such as WordPress or TikTok. In still other examples, a branch that has no prior explicit interest from the child may be recommended based on relation between that branch's content and interests the child has expressed, such as a child who is interested in video applications and in drawing or painting applications being recommended a photography application that resides on a different branch of the interest tree from prior applications used by the child.

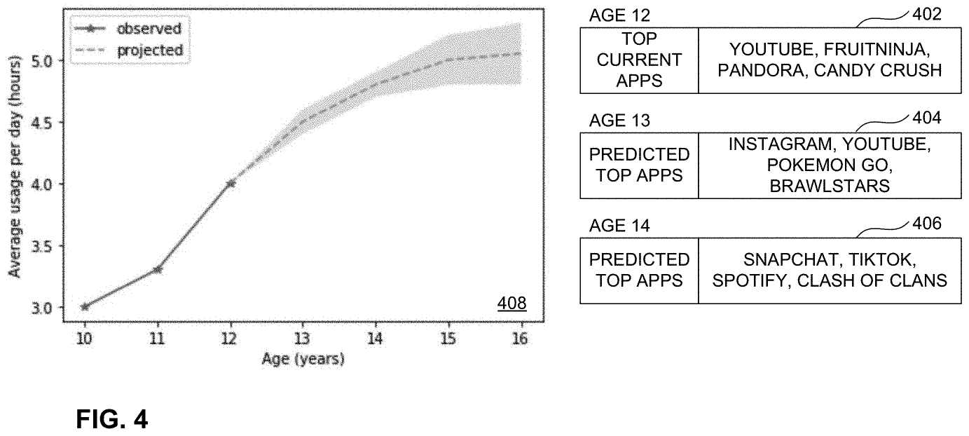

FIG. 4 shows a future application prediction example for a child, consistent with an example embodiment. Here, data from observed application usage, including the applications being used, time the application is used per day, time of day when an application is used, and other such data are collected when a child is ten to twelve years old. At the age of 12, the current top applications being used are YouTube, FruitNinja, Pandora, and Candy Crush, as shown at 402. Predicted applications for the child at age 13 are shown at 404, and predicted applications for the child at age 14 are shown at 404. Predictions become less accurate the farther in the future they look, such that applications predicted for age 14 will be less reliable than predictions made for age 13 using the child's activity data from ages 10-12. This is shown more clearly in the graph at 408, which shows usage of the top applications per day for past use as well as hours per day of use for predicted top applications for a child. More specifically, the graph shows hours per day of use of the applications shown at 402, as well as hours of use for various applications at ages 10 and 11. The chart also shows a projected hours of usage per day of the applications in box 404 at age 13 and projected hours of usage per day of the applications in box 406 at age 14, along with a range of observed usage of those applications for children at ages 13, 14, and beyond within a certain margin of error. In this example, the margin of error or shaded “observed” range for ages 13-16 is such that 90% of children having the usage characteristics observed for ages 10-12 will fall within the shaded region for application usage for ages 13-16.

The accuracy of the predictions depends significantly on the quality of the data being provided, such as complete application usage data over a period of time, the data set of other children's evolving interests over time from which predictable changes in interests can be observed, and on the model or method used to generate the predicted future usage. A child's current usage patterns over the proceeding months or years as well as the child's age, grade level, or other metric of maturity can be used as inputs, along with expressed interests of the child not yet reflected in application or web content usage, such as for a child just starting music lessons or sports. This current digital landscape from the child can be used to predict a future digital landscape as shown in FIG. 4 using observed changes in interests of other, similar children advancing through the same ages or maturity levels, which are provided to a parent or administrator of the parental control system as suggested changes in parental controls. In a further example, parental objectives such as limiting screen time, managing use in a certain category, or encouraging certain interests are also used to influence suggested changes.

The parent or administrator in a further example is provided suggested changes as a list of changes that they can accept, decline, save for later, or select to learn more about before making a decision. In other examples, the parent or administrator may elect to allow certain suggested changes to be made automatically, such as where the suggested changes are consistent with the parent or administrator's prior decisions.

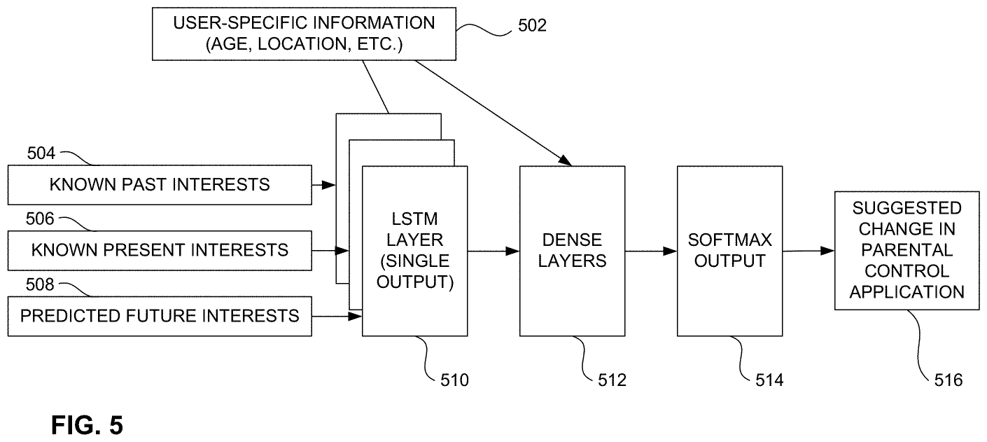

FIG. 5 shows a model for generating parental controls using a neural network having long short-term memory (LSTM), consistent with an example embodiment. Here, inputs to a long short-term memory neural network such as a recurrent neural network or a convolutional neural network include demographic information about the child, such as the child's age, geographic location, and the like at 502, and the child's application and/or web content interests. Known past interests of the child are provided to a first layer of the neural network at 504, known present interests are provided to a subsequent layer (or subsequently provided to a layer having feedback) at 506, and predicted future interests are again subsequently provided at 508. The LSTM neural network layer at 510 provides an output to dense layers 512, the output of which is encoded as a softmax output at 514. The softmax output represents likely future application and/or web content interests derived from the sequence of known past and present interest of the child provided at 504 and 506 (and in a further example on predicted future interests for earlier future years at 508 if predicting farther into the future), and the child's demographic information provided at 502. The encoded softmax output is decoded and presented to a parent or administrator of the parental control system as one or more suggested changes to parental control settings at 516.

The LSTM and dense layers of the neural network shown in FIG. 5 are in a further example trained using a roubust data set of historic data, such as providing as inputs a child's application usage from ages 10-12 and changing coefficients of the neural network using a training process to generate an output that represents the child's known interests at age 13. Repeated training using known input data and known expected output data from children of different ages with different interests results in creation of a robust neural network that can make accurate predictions across a range of ages and interests.

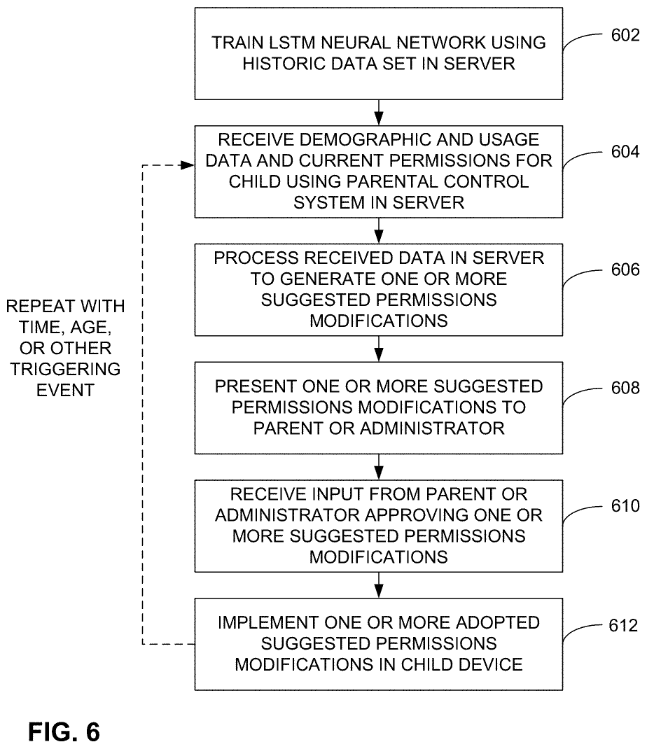

FIG. 6 is a flowchart illustrating a method of generating suggested changes to parental controls, consistent with an example embodiment. Here, a machine learning or artificial intelligence system such as a Long Short-Term Memory (LSTM) neural network is trained using historic application and/or web content preference data, such as from digital landscape database 120 of FIG. 1. The trained neural network comprises a part of recommendation engine 116, and is shown and described in greater detail in FIG. 5 and in the accompanying detailed description.

At 604, demographic data, current and historic usage data, and current permissions for a child are sent from the child's device and/or retrieved from stored settings in a server such as current settings database 118 of FIG. 1, such that the server's parental control permissions module 114 has this information available as an input to the recommendation engine 116. The server's recommendation engine processes the received data at 606 to generate one or more suggested permission modifications. If no suggested modifications are generated, the process stops and waits for a triggering event to re-evaluate the child's digital profile for potential suggested permissions modifications.

Here, one or more suggested permissions modifications are generated at 606, and are presented to a parent or administrator of the parental control system at 608. In some examples this is achieved by an alert or notification on the child's device for the parent, as a notice the next time a parent logs on to a parental control system management interface, or via a notification such as a text message or email to the parent or administrator. In a more detailed example, a notice appears on the child's device that one or more suggested permissions changes are available, and to notify the parent, in conjunction with a notice presented to the parent the next time they log on to the parental control system management interface. The management interface in some examples is presented on the child's device and is protected such as with a PIN or password, while in other examples is accessed via a parent application on their own device or via a web portal such as to parental control server 102 of FIG. 1.

Presentation of the suggested permissions changes at 608 comprises in some examples a list or other such presentation of suggested changes such that a parent can elect to approve, decline, wait to decide, or learn more about each of the suggested changes. In a further example, the suggested changes are presented in the context of a child's current application and/or web content usage and various interests via an interest tree, such as that shown in the examples of FIGS. 2 and 3. When input is received from the parent or administrator approving one or more of the suggested permissions modifications at 610, the changes are implemented on the child's device at 612. The process is repeated from 604 at the next triggering event, such as the child reaching a certain age or a certain amount of time passing since the last process completion. For example, the process may repeat once every month, every two months, every three months, every six months, or every year, or repeat when a child turns another year old, another half-year old, or another quarter-year old. In another example, a new application that becomes very popular before another triggering event occurs may trigger the process if the application is likely to be of interest to the child based on the child's demographics.

The examples shown here illustrate how permissions in a parental control system can be managed such that suggested permissions changes are presented to a parent or administrator without requiring any action on the part of the child or parent to initiate the review and generate the suggested changes. This automatic periodic review for suggested changes helps improve the experience for both the parent and the child by ensuring that age-appropriate applications and/or web content of interest are made available to the child in a timely manner, and provides the parent with various mechanisms to visualize and review the suggested changes in the context of the child's interests and related application usage. Although the parental control server, child and parent devices, and other elements shown in the examples here are shown as implemented on a computerized network client or a network server, a variety of other computerized systems may be used in other examples.

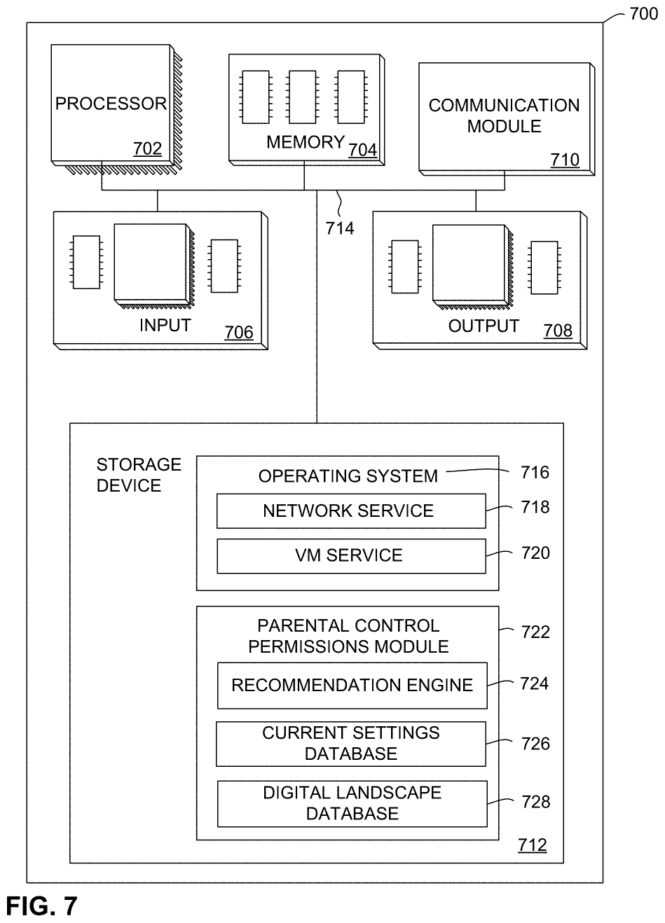

FIG. 7 is a computerized system comprising a user privacy module operable to generate a synthetic user profile and select a network egress point consistent with the synthetic profile, consistent with an example embodiment. FIG. 7 illustrates only one particular example of computing device 700, and other computing devices 700 may be used in other embodiments. Although computing device 700 is shown as a standalone computing device, computing device 700 may be any component or system that includes one or more processors or another suitable computing environment for executing software instructions in other examples, and need not include all of the elements shown here.

As shown in the specific example of FIG. 7, computing device 700 includes one or more processors 702, memory 704, one or more input devices 706, one or more output devices 708, one or more communication modules 710, and one or more storage devices 712. Computing device 700, in one example, further includes an operating system 716 executable by computing device 700. The operating system includes in various examples services such as a network service 718 and a virtual machine service 720 such as a virtual server. One or more applications, such as parental control permissions module 722 are also stored on storage device 712, and are executable by computing device 700.

Each of components 702, 704, 706, 708, 710, and 712 may be interconnected (physically, communicatively, and/or operatively) for inter-component communications, such as via one or more communications channels 714. In some examples, communication channels 714 include a system bus, network connection, inter-processor communication network, or any other channel for communicating data. Applications such as parental control permissions module 722 and operating system 716 may also communicate information with one another as well as with other components in computing device 700.

Processors 702, in one example, are configured to implement functionality and/or process instructions for execution within computing device 700. For example, processors 702 may be capable of processing instructions stored in storage device 712 or memory 704. Examples of processors 702 include any one or more of a microprocessor, a controller, a digital signal processor (DSP), an application specific integrated circuit (ASIC), a field-programmable gate array (FPGA), or similar discrete or integrated logic circuitry.

One or more storage devices 712 may be configured to store information within computing device 700 during operation. Storage device 712, in some examples, is known as a computer-readable storage medium. In some examples, storage device 712 comprises temporary memory, meaning that a primary purpose of storage device 712 is not long-term storage. Storage device 712 in some examples is a volatile memory, meaning that storage device 712 does not maintain stored contents when computing device 700 is turned off. In other examples, data is loaded from storage device 712 into memory 704 during operation. Examples of volatile memories include random access memories (RAM), dynamic random access memories (DRAM), static random access memories (SRAM), and other forms of volatile memories known in the art. In some examples, storage device 712 is used to store program instructions for execution by processors 702. Storage device 712 and memory 704, in various examples, are used by software or applications running on computing device 700 such as parental control permissions module 722 to temporarily store information during program execution.

Storage device 712, in some examples, includes one or more computer-readable storage media that may be configured to store larger amounts of information than volatile memory. Storage device 712 may further be configured for long-term storage of information. In some examples, storage devices 712 include non-volatile storage elements. Examples of such non-volatile storage elements include magnetic hard discs, optical discs, floppy discs, flash memories, or forms of electrically programmable memories (EPROM) or electrically erasable and programmable (EEPROM) memories.

Computing device 700, in some examples, also includes one or more communication modules 710. Computing device 700 in one example uses communication module 710 to communicate with external devices via one or more networks, such as one or more wireless networks. Communication module 710 may be a network interface card, such as an Ethernet card, an optical transceiver, a radio frequency transceiver, or any other type of device that can send and/or receive information. Other examples of such network interfaces include Bluetooth, 4G, LTE, or 5G, WiFi radios, and Near-Field Communications (NFC), and Universal Serial Bus (USB). In some examples, computing device 700 uses communication module 710 to wirelessly communicate with an external device such as via public network 122 of FIG. 1.

Computing device 700 also includes in one example one or more input devices 706. Input device 706, in some examples, is configured to receive input from a user through tactile, audio, or video input. Examples of input device 706 include a touchscreen display, a mouse, a keyboard, a voice responsive system, video camera, microphone or any other type of device for detecting input from a user.

One or more output devices 708 may also be included in computing device 700. Output device 708, in some examples, is configured to provide output to a user using tactile, audio, or video stimuli. Output device 708, in one example, includes a display, a sound card, a video graphics adapter card, or any other type of device for converting a signal into an appropriate form understandable to humans or machines. Additional examples of output device 708 include a speaker, a light-emitting diode (LED) display, a liquid crystal display (LCD), or any other type of device that can generate output to a user.

Computing device 700 may include operating system 716. Operating system 716, in some examples, controls the operation of components of computing device 700, and provides an interface from various applications such as parental control permissions module 722 to components of computing device 700. For example, operating system 716, in one example, facilitates the communication of various applications such as parental control permissions module 722 with processors 702, communication unit 710, storage device 712, input device 706, and output device 708. Applications such as parental control permissions module 722 may include program instructions and/or data that are executable by computing device 700. As one example, parental control permissions module 722 executes a recommendation engine module 724 program instruction sequence that trains a neural network using digital landscape database 728, such that it can use data from current settings database 726 to generate one or more suggested permissions changes for a child that are likely to be age-appropriate and of interest to the child. These and other program instructions or modules may include instructions that cause computing device 700 to perform one or more of the other operations and actions described in the examples presented herein.

Although specific embodiments have been illustrated and described herein, any arrangement that achieve the same purpose, structure, or function may be substituted for the specific embodiments shown. This application is intended to cover any adaptations or variations of the example embodiments of the invention described herein. These and other embodiments are within the scope of the following claims and their equivalents.

1. A method of managing permissions in a parental control system, comprising:
evaluating a set of current permissions settings and the age of at least one child subject to the current permissions to derive one or more suggested modifications to the current permissions, the one or more suggested modifications being determined to be age appropriate for the at least one child and to be of interest to the child.

2. The method of managing permissions in a parental control system of claim 1, wherein evaluating comprises evaluating one or more current interests of the at least one child in deriving the one or more suggested modifications.

3. The method of managing permissions in a parental control system of claim 2, wherein the one or more current interests comprise prior usage data of the at least one child.

4. The method of managing permissions in a parental control system of claim 2, wherein the one or more current interests comprise at least one of games, social, music, video, education, art, books, and news.

5. The method of managing permissions in a parental control system of claim 2, further comprising displaying a visual representation of interests as a tree of most-used applications and/or websites and potential new application and/or websites for suggested permissions modifications, grouped by related application and/or website type.

6. The method of managing permissions in a parental control system of claim 1, wherein deriving one or more suggested modifications to the current comprises considering advancement in age since the current permissions were set.

7. The method of managing permissions in a parental control system of claim 1, wherein the deriving one or more suggested modifications to the current permissions comprises evaluating a data set of activity of similar children to predict future interests of the at least one child for whom suggested permission modifications are being derived.

8. The method of managing permissions in a parental control system of claim 1, wherein determining the one or more suggested modifications to be age appropriate for the at least one child and to be of interest to the child is performed using a neural network, a decision tree, a Markov model, or other artificial intelligence.

9. The method of managing permissions in a parental control system of claim 1, wherein the current permissions include at least one of degree of content access, functional limitations, time per day, and time of day for use of one or more applications and/or websites.

10. The method of managing permissions in a parental control system of claim 1, wherein determining the one or more suggested modifications is further based on prior parental choices in configuring the current permissions.

11. The method of managing permissions in a parental control system of claim 1, further comprising recommending the one or more suggested modifications to a parent managing the parental control system.

12. The method of managing permissions in a parental control system of claim 1, wherein deriving one or more suggested modifications occurs automatically after a set period of time.

13. The method of managing permissions in a parental control system of claim 12, wherein the set period of time is biweekly, monthly, quarterly, biannually, or annually.

14. The method of managing permissions in a parental control system of claim 1, further comprising automatically updating the current permissions with the one or more suggested modifications based on one or more settings in the parental control system.

15. A method of managing permissions in a parental control system, comprising:
providing a set of current permissions settings and the age of at least one child subject to the current permissions to a parental control system;
receiving from the parental control system one or more suggested modifications to the current permissions derived from the provided current permissions settings and the age of the at least one child, the one or more suggested modifications being determined to be age appropriate for the at least one child and to be of interest to the child.

16. The method of managing permissions in a parental control system of claim 15, further comprising receiving a visual representation of interests of the at least one child as a tree of most-used applications and/or websites and potential new application and/or websites for suggested permissions modifications, grouped by related application and/or website type.

17. The method of managing permissions in a parental control system of claim 15, wherein the current permissions include at least one of degree of content access, functional limitations, time per day, and time of day for use of one or more applications and/or websites.

18. The method of managing permissions in a parental control system of claim 15, further comprising selecting a period of time since the last change in permissions after which the parental control system automatically provides the one or more suggested modifications.

19. The method of managing permissions in a parental control system of claim 15, further comprising selectively setting the parental control system to automatically update the current permissions with the one or more received suggested modifications.

20. An electronic device comprising a parental control system for managing permissions, comprising:
a processor and a memory;
a parental control module comprising a set of current permissions operable to cause the parental control system to selectively restrict at least one of degree of content access, functional limitations, time per day, and time of day for use of one or more applications and/or websites on the electronic device; and
a suggested modification module operable to provide one or more suggested modifications to the set of current permissions based on the set of current permissions and the age of at least one child subject to the current permissions, the one or more suggested modifications being determined to be age appropriate for the at least one child and to be of interest to the child.
